(19) United States
(12) Patent Application Publication
(10) Pub. No.: US 2021/0105381 A1
(43) Pub. Date: Apr. 8, 2021

(54) CONTROL DEVICE AND NON-TRANSITORY COMPUTER READABLE MEDIUM FOR CONTROL

(71) Applicant: FUJI XEROX CO., LTD., Tokyo (JP)

(72) Inventor: Naoto OGAWA, Kanagawa (JP)

(73) Assignee: FUJI XEROX CO., LTD., Tokyo (JP)

(21) Appl. No.: 16/857,555

(22) Filed: Apr. 24, 2020

(30) Foreign Application Priority Data
Oct. 2, 2019 (JP) 2019-182089

(51) Int. Cl. H04N 1/44

(52) U.S. Cl. CPC H04N 1/444; H04N 1/4433; H04N 1/4426

(57) ABSTRACT

A control device includes a processor. The processor obtains multiple setting registrations and permission level information associated with each of the multiple setting registrations, in response to an output instruction for outputting the multiple setting registrations to the outside. In the multiple setting registrations, process settings for functions of a device are registered in advance. The processor generates a list including at least one setting registration associated with permission level information indicating use permission for a user who transmits the output instruction. The at least one setting registration is among the multiple setting registrations.

### CROSS-REFERENCE TO RELATED APPLICATIONS

This application is based on and claims priority under 35 USC 119 from Japanese Patent Application No. 2019-182089 filed Oct. 2, 2019.

### BACKGROUND

### (i) Technical Field

The present disclosure relates to a control device and a non-transitory computer readable medium for control.

### (ii) Related Art

Japanese Unexamined Patent Application Publication No. 2010-211416 discloses an image processing apparatus having user permission information and abbreviated setting information. The user permission information defines accessible documents and destinations, to which the documents may be transmitted, for each user. The abbreviated setting information includes a combination of a document and a destination. The image processing apparatus refers to the abbreviated setting information in accordance with a received job, and transmits the document to the destination described in the combination. The image processing apparatus includes an abbreviated-setting-information registering unit and a user permission assigning unit. The abbreviated-setting-information registering unit registers the abbreviated setting information. When the abbreviated-setting-information registering unit is to register the abbreviated setting information, the user permission assigning unit refers to the user permission information, and assigns reference permission for the abbreviated setting information to a user who may access to the document that is registered as the abbreviated setting information and who may transmit the document to the destination that is registered as the abbreviated setting information.

Japanese Unexamined Patent Application Publication No. 2012-249183 discloses an import control program causing a computer to perform a first obtaining step, a second obtaining step, a comparing step, and an import step. In the first obtaining step, macro registration information and first environment setting information are obtained from a first image processing apparatus. The macro registration information includes one or more macros in which operation procedures are registered. The first environment setting information describes setting information of setting items in the functions of the first image processing apparatus and options installed in the first image processing apparatus. In the second obtaining step, second environment setting information describing setting information of setting items in the functions of a second image processing apparatus and options installed in the second image processing apparatus is obtained from the second image processing apparatus. In the comparing step, the first environment setting information is compared with the second environment setting information. In the import step, when the comparison result in the comparing step indicates that there are options which are installed in the first image processing apparatus and which are not installed in the second image processing apparatus, the macro registration information, from which the macros using the options have been excluded, is imported to the second image processing apparatus.

In a technique, a user may optionally register, in advance, process settings for the functions of such a device. Such setting registrations (hereinafter also called one-touch functions) registered by a user may be copied to a different device. In this case, to prevent mismatching of permission level or the like between the setting registrations, all of the setting registrations registered in the device need to be copied.

### SUMMARY

Aspects of non-limiting embodiments of the present disclosure relate to a technique of copying setting registrations individually without occurrence of mismatching of permission level or the like between the setting registrations, compared with the case in which all of the setting registrations registered in a device are copied.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a control device including a processor. The processor obtains multiple setting registrations and permission level information associated with each of the multiple setting registrations, in response to an output instruction for outputting the multiple setting registrations to the outside. In the multiple setting registrations, process settings for functions of a device are registered in advance. The processor generates a list including at least one setting registration associated with permission level information indicating use permission for a user who transmits the output instruction. The at least one setting registration is among the multiple setting registrations.

### BRIEF DESCRIPTION OF THE DRAWINGS

Exemplary embodiment of the present disclosure will be described in detail based on the following figures, wherein:

FIG. 1 is a schematic diagram illustrating the overall configuration including multifunction devices, in which control devices are included, and also including a server, according to the present exemplary embodiment;

FIG. 2 is a schematic diagram illustrating an exemplary screen on which setting registrations according to the present exemplary embodiment are displayed;

FIG. 3 is a block diagram illustrating the hardware configuration of a control device according to the present exemplary embodiment;

FIG. 4 is a block diagram illustrating the hardware configuration of a server according to the present exemplary embodiment;

FIG. 5 is a diagram illustrating an exemplary permission level information table according to the present exemplary embodiment;

FIG. 6 is a diagram illustrating an exemplary output data file according to the present exemplary embodiment;

FIG. 7 is a diagram illustrating use permission level for functions of an input-side multifunction device;

FIG. 8 is a flowchart of an example about an output instruction to output setting registrations to the outside by a control device according to the present exemplary embodiment;

FIG. 9 is a flowchart of a process of generating an output candidate list;

FIG. 10 is a flowchart of an example about an input process for inputting setting registrations from a multifunction device which is present outside;

FIG. 11 is a flowchart of a process of generating an input candidate list;

FIG. 12 is a flowchart of the process of generating an input candidate list, which continues from that in FIG. 11; and

FIG. 13 is a flowchart of the process of generating an input candidate list, which continues from that in FIG. 12.

### DETAILED DESCRIPTION

An exemplary embodiment of the present disclosure will be described below with reference to the drawings. In the figures, components and parts, which are identical or equivalent, are designated with identical reference characters.

### EXEMPLARY EMBODIMENT

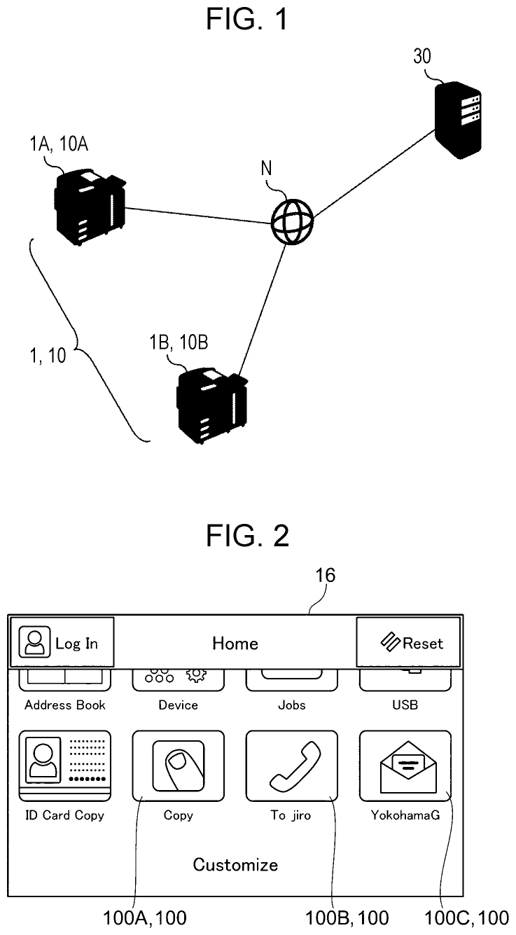

FIG. 1 is a schematic diagram illustrating the overall configuration including multifunction devices 1, in which control devices 10 are included, and also including a server 30, according to the present exemplary embodiment.

### Overall Configuration

As illustrated in FIG. 1, a control system includes the multiple multifunction devices 1 (for example, a first multifunction device 1A and a second multifunction device 1B) including the control devices 10, and the server 30. The multiple multifunction devices 1 and the server 30 are connected communicatively to each other over a network N. The network N may be the Internet or a private local-area network (LAN).

In the present exemplary embodiment, the multiple multifunction devices 1 include the respective control devices 10 (for example, a first control device 10A and a second control device 10B). As illustrated in FIG. 2, each multifunction device 1 displays, on a display unit 16 described below, icons 100A, 100B, and 100C for setting registrations (hereinafter also referred to as “one-touch apps” or “apps”) in which process settings for the functions of the multifunction device 1 are registered in advance. A user specifies a one-touch app 100. Thus, without making settings every time, the user may make the multifunction device 1 perform a routine process by using the settings registered in advance in the one-touch app 100. The multifunction device 1 is an exemplary device.

In the present exemplary embodiment, each control device 10 has a function of copying one-touch apps 100, which are registered in any of the multifunction devices 1, to another multifunction device 1. A description will be made below by taking, as an example, the case in which the control device 10A and the control device 10B are used to copy one-touch apps, which are registered in the first multifunction device 1A, to the second multifunction device 1B. The server 30 temporarily stores one-touch apps 100 which are output (exported) from the multifunction device 1A. The server 30 makes it possible to select any one-touch apps 100 from one-touch apps 100 extracted from a single or multiple multifunction devices, and makes it possible to input (import) the selected one-touch apps 100 to the different multifunction device 1B.

FIG. 2 is a schematic diagram illustrating an exemplary screen on which setting registrations according to the present exemplary embodiment are displayed.

Each multifunction device 1 includes its display unit 16 (see FIG. 1). As illustrated in FIG. 2, on a display unit 16, for example, icons for “Copy” 16A which is an app having a copy function, “To Jiro” 16B which is an app having a telephone function, and “YokohamaG” 16C which is an app having an electronic mail function are displayed. These apps, to which specific parameters are added, are registered individually, and may be used only by users who have been given permission. One of the icons of these apps is selected, and is touched or pressed by using their hands. Thus, the specific one-touch app 100 is activated.

### Configuration of Each Multifunction Device

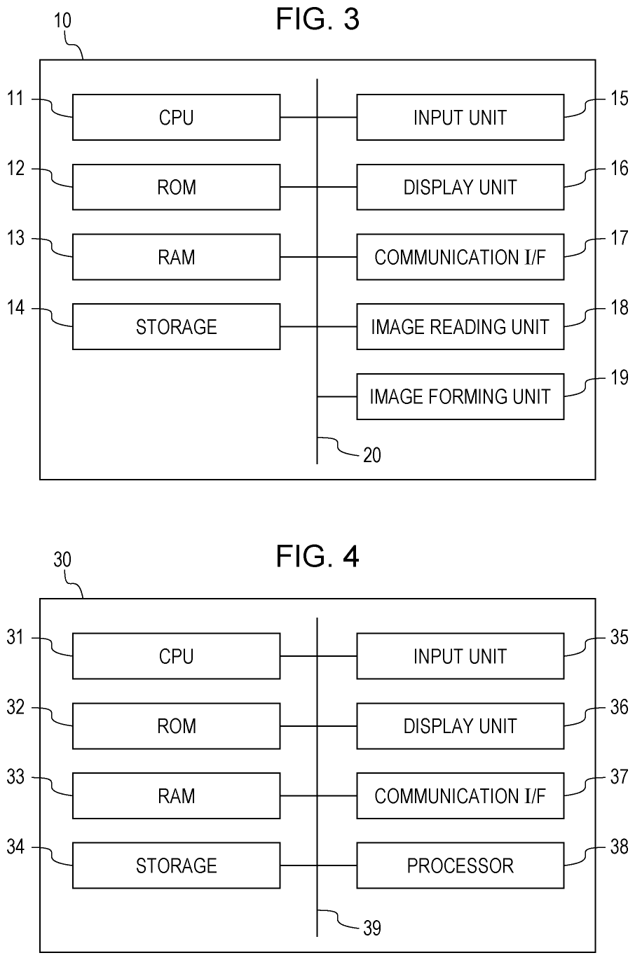

FIG. 3 is a block diagram illustrating the hardware configuration of each multifunction device according to the present exemplary embodiment.

As illustrated in FIG. 3, the multifunction device 1 includes a central processing unit (CPU) 11, a read only memory (ROM) 12, a random access memory (RAM) 13, a storage 14, an input unit 15, the display unit 16, a communication interface 17, an image reading unit 18, and an image forming unit 19. The components are connected communicatively to each other through a bus 20.

The CPU 11, which is a central processing unit, executes various programs and controls the units. That is, the CPU 11 reads programs from a storage device, such as the ROM 12 or the storage 14, and executes the programs by using the RAM 13 as a work area. The CPU 11 controls the components and performs various computing processes according to the programs recorded in the ROM 12 or the storage 14.

In the present exemplary embodiment, the ROM 12 or the storage 14 stores output programs for outputting or inputting one-touch apps 100 in order to copy the one-touch apps 100. The ROM 12 or the storage 14 stores information about the one-touch apps 100. For example, the information about one-touch apps 100 describes process settings, which are registered in advance as the one-touch apps 100, for the functions of the multifunction device 1. In addition, the information about one-touch apps 100 describes permission level information indicating permission level for use of the one-touch apps 100 and user information describing users who have created or set the one-touch apps 100.

The ROM 12 stores various programs and various data. The RAM 13, which serves as a work area, stores programs or data temporarily. The storage 14, which is formed of a hard disk drive (HDD) or a solid state drive (SSD), stores various programs including an operating system, and various data.

The input unit 15, which includes hard keys and softkeys, is used to perform various input operations.

The display unit 16, which is, for example, a liquid-crystal display, displays various types of information. The display unit 16 may function as the input unit 15. As described above, on the display unit 16, the icons 100A, 100B, and 100C for the one-touch apps 100 managed by the control device 10 described below may be displayed (see FIG. 2).

The communication interface 17 is an interface for communicating with other equipment, such as a client terminal or a different server. For example, a standard, such as Ethernet™, Fiber Distributed Data Interface (FDDI), or Wi-Fi™, may be used.

In the multifunction device 1, the image reading unit 18, for example, performs image processing such as reading an image on a print medium. The read image is temporarily stored in the RAM 13. When the multifunction device 1 functions as an image forming apparatus, the multifunction device 1 performs image processing, such as forming an image on a recording medium, for example, a sheet, in accordance with an image processing job (hereinafter called a print job) from a user. The requested process may be performed immediately, or may be reserved by a user and performed at a timing at which the user needs to perform the process.

### Configuration of Server

FIG. 4 is a block diagram illustrating the hardware configuration of a server according to the present exemplary embodiment.

As illustrated in FIG. 4, the server 30 includes a CPU 31, a ROM 32, a RAM 33, a storage 34, an input unit 35, a display unit 36, a communication interface 37, and a processor 38. The components are connected communicatively to each other through a bus 39.

The CPU 31, which is a central processing unit, executes various programs and controls the units. That is, the CPU 31 reads programs from a storage device, such as the ROM 32 or the storage 34, and executes the programs by using the RAM 33 as a work area. The CPU 31 controls the components and performs various computing processes according to the programs recorded in the ROM 32 or the storage 34.

In the present exemplary embodiment, the ROM 32 or the storage 34 stores information about one-touch apps 100 which is output from a multifunction device 1. For example, the information about one-touch apps 100 describes process settings, which are registered in advance as the one-touch app 100, for the functions of a multifunction device 1. The information about one-touch apps 100 describes permission level information indicating permission level for use of the one-touch apps and user information describing users who have created or set the one-touch apps 100. In the present exemplary embodiment, the case in which the information about one-touch apps 100, which is output from the output-side multifunction device 1A outputting the one-touch apps 100, is stored in the server 30 will be described. However, the one-touch apps 100, which the output-side multifunction device 1A receives an instruction to output, may be specified, and the specification information may be held in the multifunction device 1A as it is.

The ROM 32 stores various programs and various data. The RAM 33, which serves as a work area, stores programs or data temporarily. The storage 34, which is formed of an HDD or an SSD, stores various programs including an operating system, and various data.

The input unit 35, which includes hard keys or the like, is used to perform various input operations.

The display unit 36, which is, for example, a liquid-crystal display, displays various types of information. The display unit 36 may function as the input unit 35.

The communication interface 37 is an interface for communicating with other equipment, such as a client terminal or a different server. For example, a standard, such as Ethernet™, FDDI, or Wi-Fi™, is used.

The processor 38 performs various types of processing with a control device 10 described below, when necessary. Specifically, for example, when permission level information, user information, and creator information, which are stored in the server 30, need to be processed, for example, edited, through communication with a control device 10, the data is edited.

### Permission Level Information Table

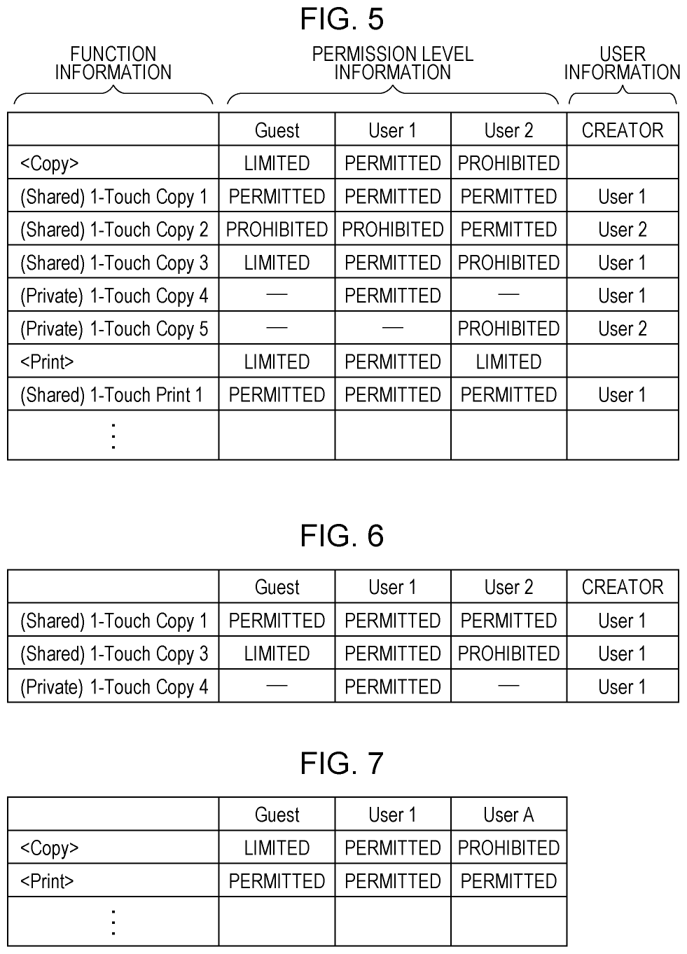

FIG. 5 is a diagram illustrating an exemplary permission level information table according to the present exemplary embodiment. A permission level information table is stored in a storage device, such as the ROM 12 or the storage 14 of each multifunction device 1.

The table illustrated in FIG. 5 describes use permission level of each user for typical functions of the multifunction device 1, such as copying. When one-touch apps 100 are registered in the multifunction device 1, use permission level for each user is described for every one-touch app 100. Since one-touch apps 100 are registered in the multifunction device 1A outputting one-touch apps 100, as illustrated in FIG. 5, permission level information for the one-touch apps 100 is also included in the table in addition to that for typical functions of the multifunction device 1.

As illustrated in FIG. 5, a table, which serves as exemplary information about one-touch apps 100, is stored in each multifunction device 1. The table illustrated in FIG. 5 includes function information describing the functions of the multifunction device 1 in which the one-touch apps 100 are set, permission level information for each one-touch app 100, and user information describing the creators of the one-touch apps 100. For example, the table illustrated in FIG. 5 describes the function information of the multifunction device 1 in the leftmost column. The function information also includes information which describes whether each one-touch app 100 is set so as to be shared between users or be used by a specific individual user, and which is classified according to the functions executable by the multifunction device 1. Hereinafter, a one-touch app 100, which is set so as to be shared between users, is called a shared one-touch app or a shared app. A one-touch app 100, which is set so as to be used by a specific individual user, is called a private one-touch app or a private app.

In multiple center columns of the table illustrated in FIG. 5, use permission level for the functions of the multifunction device 1 and use permission level for the one-touch apps 100 are set for each guest user (hereinafter called a guest) who has not logged in the multifunction device 1 and for each specific user who has logged in the multifunction device 1. For example, for the copy function, “<Copy>”, of the multifunction device which is performed in the case where no one-touch apps 100 are used, the following settings are made: use by a guest is “limited”; use by User 1 is “permitted”; use by User 2 is “prohibited”. In this example, “limited” indicates that part of the function is allowed to be used. For example, this indicates that, in use of the copy function, monochrome copying is allowed, but color copying is prohibited. For example, for a one-touch app, “(Shared) 1-Touch Copy 1”, the following settings are made: use by a guest is “permitted”; use by User 1 is “permitted”; use by User 2 is “permitted”. In the table illustrated in FIG. 5, user information describing the creators of the one-touch apps 100 is set in the rightmost column.

As illustrated in FIG. 5, for the print function, “<Print>”, permission level information and user information are set, and are handled in the same manner as that for the case of the copy function. Thus, in the present exemplary embodiment, a description will be made by taking the copy function.

### Output Data File

FIG. 6 is a diagram illustrating an exemplary output data file according to the present exemplary embodiment.

An output data file is generated by a user selecting the outputting on the output-side multifunction device 1A. For example, when the multifunction device 1A has the table illustrated in FIG. 5, the output data file includes part of the information which is extracted from the table. The output data file includes at least the function information and the permission level information. The output data file may include the user information. The output data file is stored in the server 30.

Information Used when Control Device Receives Input Operation

FIG. 7 is a diagram illustrating use permission level for the functions of a multifunction device which receives one-touch apps. When one-touch apps are to be input to the multifunction device 1B, permission level information for the functions of the multifunction device 1B is referred to. The details will be described below.

### Operations Performed by Control Device

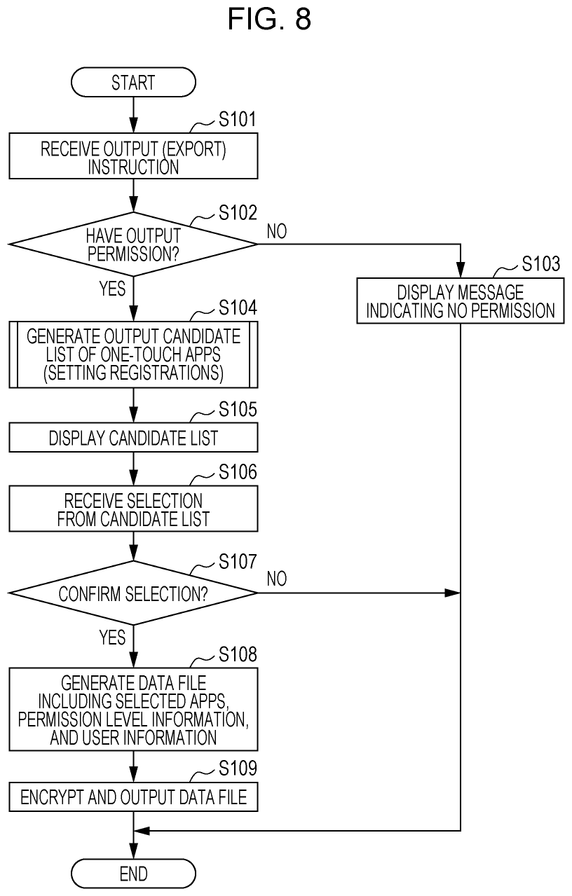

Operations performed by a control device 10 according to the present exemplary embodiment will be described with reference to FIGS. 8 to 13.

### Output Process (Export)

FIG. 8 is a flowchart of an exemplary output process for outputting, to the outside, setting registrations (one-touch apps) in the control device 10A according to the present exemplary embodiment. The CPU 11 of the control device 10A reads input/output programs (control programs) for inputting/outputting one-touch apps, from a storage device such as the storage 14, and loads the programs on the RAM 13, thus performing the output process.

As illustrated in FIG. 8, in step S101, the CPU 11 receives an output instruction, from a user, to output one-touch apps 100. The output instruction is received, for example, through user operations according to a menu displayed on the display unit 16 of the multifunction device 1A.

In step S102, the CPU 11 determines whether or not the user, who is performing the operations, has output permission for one-touch apps 100. The output permission is, for example, special permission, such as that for a system administrator or a system operator. The output permission is registered, for example, in association with user IDs in the server 30. The CPU 11 asks the server if the user ID used when the user logs in the multifunction device 1A is associated with the output permission. If the user ID is associated with the output permission, the CPU 11 determines that the user has the output permission.

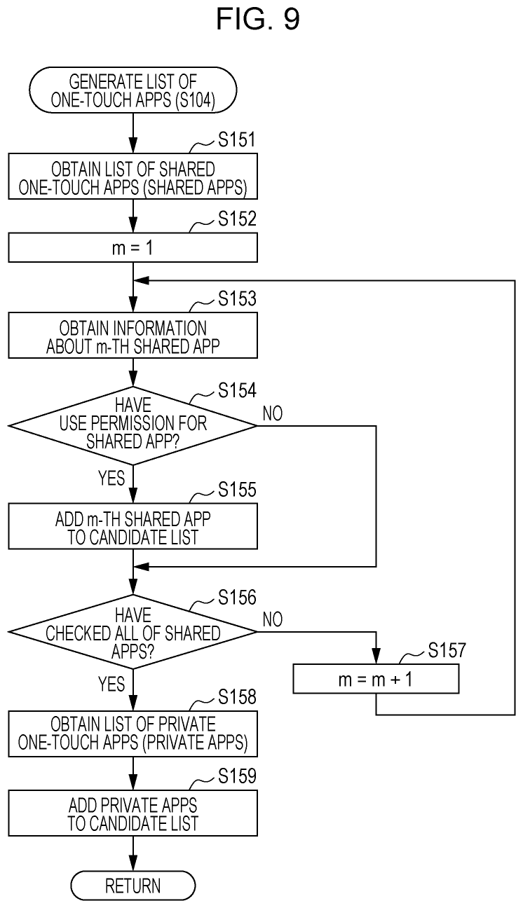

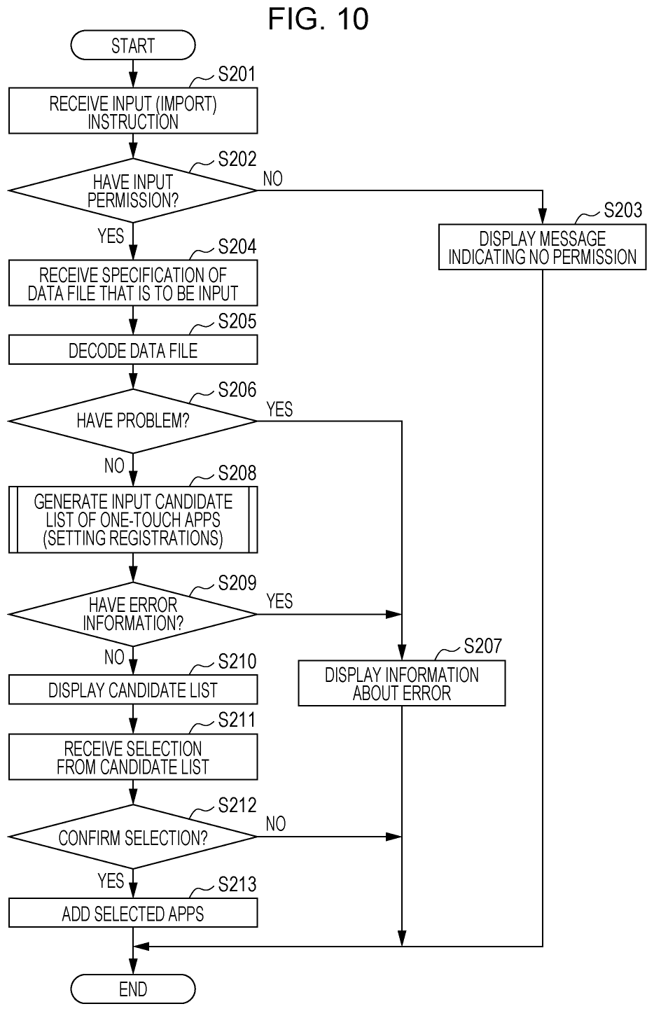

If the user does not have the output permission (NO in step S102), in step S103, the CPU 11 displays, on the display unit 16, a message that the user does not have permission to output one-touch apps 100. If the user has the output permission (YES in step S102), in step S104, the CPU 11 generates an output candidate list of one-touch apps 100 which may be output. The operation of generating an output candidate list will be described below in detail by referring to FIG. 9.

In step S105, the CPU 11 displays the output candidate list on the display unit 16. In step S106, the CPU 11 receives selection of one-touch apps 100, which are to be output, from the output candidate list. The selection of one-touch apps 100 is received, for example, by touching one-touch apps 100 listed in the output list displayed on the display unit 16.

In step S107, the CPU 11 determines whether or not the selection has been confirmed. The confirmation of selection of one-touch apps 100 is determined, for example, by displaying, on the display unit 16, a message such as “Confirm one-touch apps which are to be output?” and detecting a touch on a button such as “OK”.

If the selection has not been confirmed (NO in step S107), that is, if the operation of outputting one-touch apps 100 has been canceled, the CPU 11 ends the output process. If the selection has been confirmed (YES in step S107), in step S108, the CPU 11 generates an output data file which includes the selected one-touch apps 100 and which also includes the permission level information and user information for the one-touch apps 100.

In step S109, the CPU 11 encrypts the generated output data file, and outputs it to the server 30. When multiple multifunction devices 1 generate output data files, the output data files may be transmitted to the server 30 and may be stored in the server 30.

By referring to FIG. 9, the process of generating an output candidate list in step S104 will be described in detail. FIG. 9 is a flowchart of a process of generating an output candidate list. The output candidate list is an exemplary list or first list.

In step S151, the CPU 11 extracts shared one-touch apps (shared apps) from all of the one-touch apps 100 (for example, see FIG. 5) stored in the multifunction device 1A, and obtains them as a list. In step S152, the CPU 11 substitutes one, which is an initial value, to a variable m. In step S153, the CPU 11 obtains information about the m-th shared app in the list.

In step S154, the CPU 11 determines whether or not the user who has transmitted the output instruction has use permission for the m—the shared app. For example, when User 1 is performing the output process, the use permission level of User 1 for the one-touch app, “(Shared) 1-Touch Copy 2”, illustrated in FIG. 5 is “prohibited”. In this case, the CPU 11 determines that User 1 does not have use permission for the one-touch app, “(Shared) 1-Touch Copy 2”.

If the user does not have use permission for the shared app (NO in step S154), the CPU 11 causes the process to proceed to step S156. If the user has use permission for the shared app (YES in step S154), the CPU 11 adds the m-th shared app to the output candidate list in step S155.

In step S156, the CPU 11 determines whether or not all of the shared apps have been checked. If all of the shared apps have not been checked (NO in step S156), in step S157, the CPU 11 increments the variable m by one, and causes the process to return to step S153. If all of the shared apps have been checked (YES in step S156), in step S158, the CPU 11 extracts the private one-touch apps (private apps) from all of the one-touch apps (for example, see FIG. 5) stored in the multifunction device 1A, and obtains them as a list.

In step S159, the CPU 11 adds the private apps to the output candidate list, and causes the process to proceed to step S105 in FIG. 8.

### Input Process (Import)

FIG. 10 is a flowchart of an exemplary input process for inputting setting registrations (one-touch apps) by using the outside multifunction device 1B. In the control device 10B to which one-touch apps 100 are to be input, the CPU 11 reads the input/output programs (control programs) for one-touch apps 100 from a storage device such as the storage 14, and loads the programs on the RAM 13, thus performing the input process. In the control device 10A, the CPU 11 reads the input/output program for one-touch apps 100 from a storage device such as the storage 14, and loads the programs on the RAM 13, thus performing the output process.

As illustrated in FIG. 10, in step S201, the CPU 11 receives an input instruction from a user to input one-touch apps 100. The input instruction is received, for example, through user operations according to a menu displayed on the display unit 16 of the multifunction device 1A.

In step S202, the CPU 11 determines whether or not the user, who is performing the operations, has input permission for one-touch apps 100. The input permission is special permission, such as that for a system administrator or a system operator. The input permission is registered, for example, in association with user IDs in the server 30. The CPU 11 asks the server if the user ID used when the user logs in the multifunction device 1B is associated with the input permission. If the user ID is associated with the input permission, the CPU 11 determines that the user has the input permission.

If the user does not have the input permission (NO in step S202), in step S203, the CPU 11 displays, on the display unit 16, a message that the user does not have permission for inputting one-touch apps 100. If the user has the input permission (YES in step S202), in step S204, the CPU 11 receives specification of a data file that is to be input. The data file is the output data file generated in step S108 in FIG. 8. When the server 30 stores multiple output data files, at least one data file may be selected as an input target from the multiple output data files. For example, a list of multiple output data files is transmitted from the server 30 to the multifunction device 1B, and the list is displayed on the display unit 16 of the multifunction device 1B. The user selects at least one file from the list. Thus, at least one data file that is an input target is specified.

In step S205, the CPU 11 downloads the specified data file from the server 30, or decodes the file in the server 30.

In step S206, the CPU 11 determines whether or not the decoded data file has a problem. For example, the CPU 11 determines whether or not the data file has a problem by determining whether or not data has been damaged.

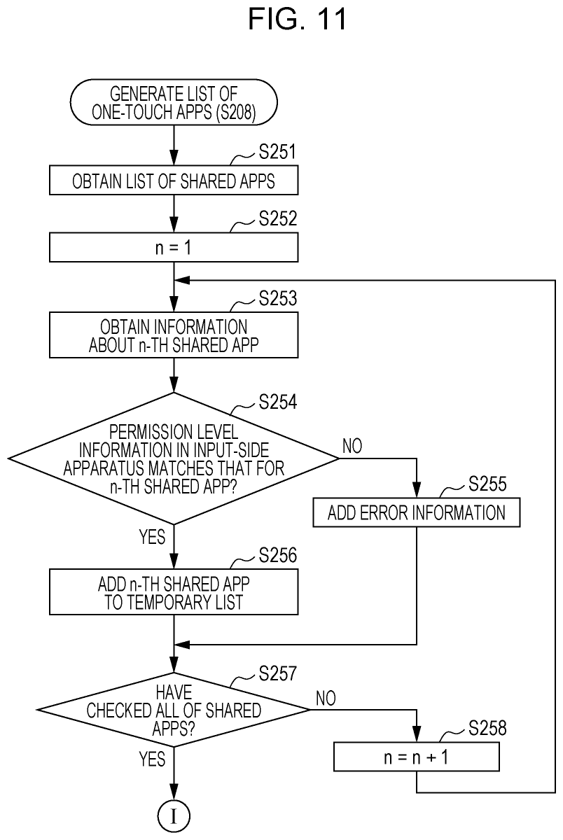

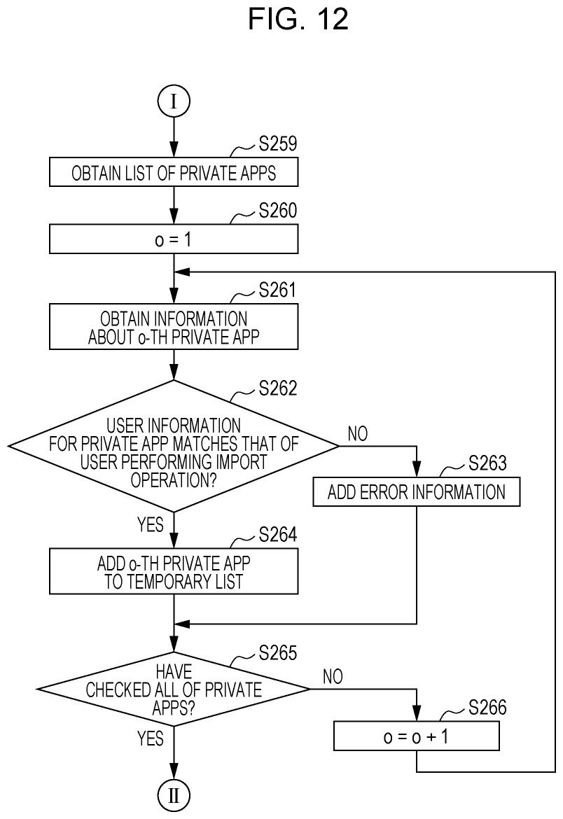

If the data file has a problem (YES in step S206), in step S207, the CPU 11 displays a message that the data file has a problem, and displays information about the error. If the at least one data file does not have a problem (NO in step S206), in step S208, the CPU 11 generates an input candidate list including one-touch apps 100 which may be input. The operation of generating an input candidate list will be described in detail below by referring to FIGS. 11 to 13.

In step S209, the CPU 11 determines whether or not error information has been added in generating the input candidate list. The error information is generated when there are one-touch apps 100 which are included in the at least one data file specified in step S204 and which are not included in the input candidate list. The input candidate list is an exemplary list or second list.

If there is error information (YES in step S209), the CPU 11 causes the process to proceed to step S207, and displays, on the display unit 16, information about the error indicated by the error information. Thus, the user may know the reason why the one-touch apps 100 are not included in the input candidate list. If there is no error information (NO in step S209), in step S210, the CPU 11 displays the input candidate list on the display unit 16. In step S211, the CPU 11 receives selection of one-touch apps 100, which are to be input, from the input candidate list. The selection of one-touch apps 100 is received by touching one-touch apps 100 listed in the input list displayed on the display unit 16.

In step S212, the CPU 11 determines whether or not the selection has been confirmed. The confirmation of selection of one-touch apps 100 is determined, for example, by displaying, on the display unit 16, a message such as “Confirm one-touch apps that are to be input?”, and detecting a touch on a button such as “OK”.

If the selection has not been confirmed (NO in step S212), that is, the input operation on one-touch apps 100 is canceled, the CPU 11 ends the input process. If the selection has been confirmed (YES in step S212), in step S213, the CPU 11 copies the selected one-touch apps, and adds the copied apps to the multifunction device 1B.

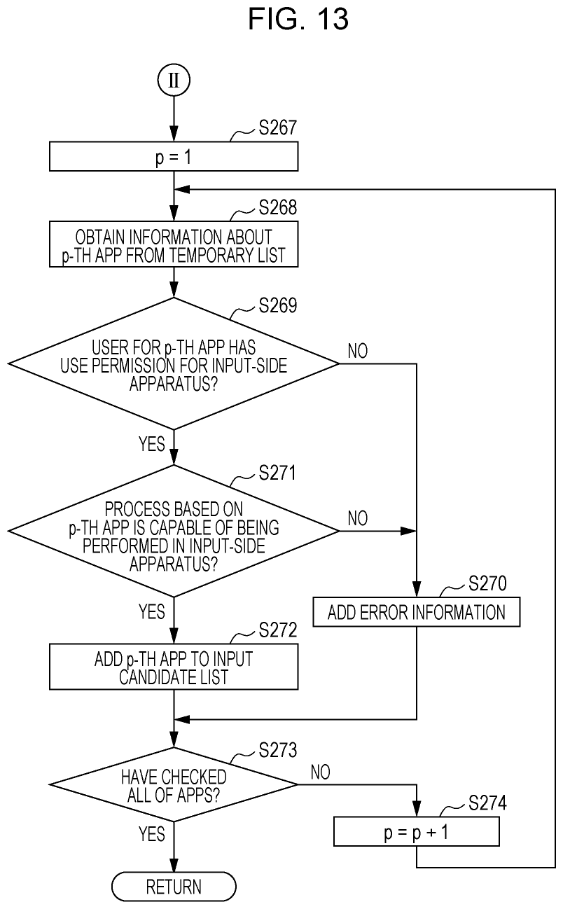

Referring to FIGS. 11 to 13, the process of generating of an input candidate list in step S208 will be described in detail. FIG. 11 is a flowchart of the process of generating an input candidate list. FIG. 12 is a flowchart of the process of generating an input candidate list, which continues from that in FIG. 11. FIG. 13 is a flowchart of the process of generating an input candidate list, which continues from that in FIG. 12.

In step S251, the CPU 11 extracts the shared one-touch apps (shared apps) from the one-touch apps 100 in the at least one data file specified in step S204, and obtains the extracted apps as a list. In step S252, the CPU 11 substitutes one, which is an initial value, to a variable n. In step S253, the CPU 11 obtains information about the n-th shared app in the list.

In step S254, the CPU 11 determines whether or not permission level information, which is set originally in the multifunction device 1B (hereinafter also called the input-side apparatus) for the same function as that performed by the n-th shared app, matches permission level information which is set for the n-th shared app. For example, the case in which the one-touch app, “(Shared) 1-Touch Copy 1”, in the data file illustrated in FIG. 6 is the n-th shared app, and in which the use permission level illustrated in FIG. 7 is set in the multifunction device 1B will be discussed. Assume that the user who is going to input one-touch apps 100 is User 1. For the one-touch app, “(Shared) 1-Touch Copy 1”, in FIG. 6, “permitted” is set to User 1, and User 1 has use permission for the copying. For “Copy” in FIG. 7, “permitted” is set to User 1. In this case, the CPU 11 determines that the pieces of permission level information match each other. There may be the case in which permission level information has not been set for the user, who is going to input one-touch apps 100, in the input-side apparatus. In this case, by using the permission level information of a guest as the permission level information of the user who is going to input one-touch apps 100, comparison with permission level information for the one-touch apps 100 that are to be input may be made.

If the permission level information for the input-side apparatus does not match that for the n-th shared app (NO in step S254), the CPU 11 adds error information, indicating that the use permission levels do not match each other, to the n-th shared app. If the permission level information for the input-side apparatus matches that for the n-th shared app (YES in step S254), the CPU 11 adds the n-th shared app to a temporary list in step S256.

In step S257, the CPU 11 determines whether or not all of the shared apps have been checked.

If all of the shared apps have not been checked (NO in step S257), in step S258, the CPU 11 increments the variable n by one, and causes the process to return to step S253. If all of the shared apps have been checked (YES in step S257), in step S259, the CPU 11 extracts the private one-touch apps (private apps) from the one-touch apps in the at least one data file specified in step S204, and obtains the private apps as a list.

In step S260, the CPU 11 substitutes one, which is an initial value, to a variable o. In step S261, the CPU 11 obtains information about the o-th private app.

In step S262, the CPU 11 determines whether or not the user information associated with the o-th private app matches the user information of the user who is going to perform the import operation. The user information of the user, who is going to perform the import operation, is the user information obtained when the user logs in the multifunction device 1B.

If the pieces of user information do not match each other (NO in step S262), in step S263, the CPU 11 adds error information to the o-th private app. If the pieces of user information match each other (YES in step S262), in step S264, the CPU 11 adds the o-th private app to the temporary list.

In step S265, the CPU 11 determines whether or not all of the private apps have been checked. If all of the private apps have not been checked (NO in step S265), in step S266, the CPU 11 increments the variable o by one, and causes the process to return to step S261. In step S267, the CPU 11 substitutes one, which is an initial value, to a variable p. In step S268, the CPU 11 obtains information about the p-th one-touch app 100 from the temporary list.

In step S269, the CPU 11 determines whether or not the user indicated by the user information associated with the p-th one-touch app 100 has use permission for the input-side apparatus.

If the user does not have use permission for the input-side apparatus (NO in step S269), in step S270, the CPU 11 adds error information to the p-th one-touch app 100. If the user has use permission for the input-side apparatus (YES in step S269), in step S271, the CPU 11 determines whether or not the process may be performed in the input-side apparatus by using the settings based on the p-th one-touch app 100. For example, assume the case in which, while color copying is set in the p-th one-touch app, only monochrome copying is performed in the multifunction device 1B which is the input-side apparatus. In this case, the CPU 11 determines that the process based on the p-th one-touch app 100 is not capable of being performed.

If the process based on the p-th one-touch app 100 is not capable of being performed (NO in step S271), the CPU 11 causes the process to proceed to step S270. If the process based on the p-th one-touch app 100 is capable of being performed (YES in step S271), in step S272, the CPU 11 adds the p-th one-touch app 100 to the input candidate list.

In step S273, the CPU 11 determines whether or not all of the one-touch apps 100 in the temporary list have been checked. If all of the one-touch apps 100 have not been checked (NO in step S273), in step S274, the CPU 11 increments the variable p by one, and causes the process to return to step S268.

If all of the one-touch apps 100 have been checked (YES in step S273), the CPU 11 causes the process to proceed to step S210 in FIG. 10.

Thus, in the present exemplary embodiment, a control program included in a multifunction device 1 causes a computer to perform the following procedures: obtaining multiple one-touch apps 100 and permission level information associated with each of the one-touch apps 100, in response to an output instruction for outputting, to the outside, the multiple one-touch apps 100 in which process settings for functions of the multifunction device 1 are registered in advance; and generating an output candidate list including at least one one-touch app 100 which is among the multiple one-touch apps 100 and which is associated with permission level information indicating use permission for a user who transmits the output instruction.

A control program included in a multifunction device 1 causes a computer to perform the following procedures: obtaining multiple one-touch apps 100 and permission level information associated with each of the one-touch apps 100, in response to an input instruction for inputting the multiple one-touch apps 100, in which process settings for functions of the first multifunction device 1A are registered in advance, to the second multifunction device 1B; and generating an input candidate list including at least one one-touch app 100 associated with permission level information matching permission level information associated with a one-touch app 100 registered already for a corresponding function of the second multifunction device 1B. The at least one one-touch app 100 is among the multiple one-touch app 100.

A control program included in a multifunction device 1 causes a computer to perform the following procedures: obtaining multiple one-touch apps 100 and permission level information associated with each of the multiple one-touch apps 100, in response to a copy instruction for copying the multiple one-touch apps 100, in which process settings for functions of the first multifunction device 1A are registered in advance, to the second multifunction device 1B; generating an output candidate list including at least one one-touch app 100 which is among the multiple one-touch apps 100 and which is associated with permission level information indicating use permission for a user who transmits the copy instruction; and generating an input candidate list including at least one one-touch app 100 which is among the at least one one-touch app 100 included in the output candidate list and which is associated with permission level information matching permission level information associated with a one-touch app 100 registered already for the corresponding function of the second multifunction device 1B.

The processes described above may be implemented also by using a dedicated hardware circuit. In this case, a single piece of hardware may be used to perform the processes, or pieces of hardware may be used to perform the processes. In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The program for operating a control device 10 may be provided by using a computer-readable recording medium, such as a Universal Serial Bus (USB) memory, a flexible disk, or a compact disc read only memory (CD-ROM). Alternatively, the program may be provided online over a network such as the Internet. In this case, the program recorded in a computer-readable recording medium is typically transferred to a memory, a storage, or the like for storage. The program may be provided, for example, as single application software, or may be included in software in each apparatus as a function of a control device 10.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A control device comprising:
a processor configured to
obtain a plurality of setting registrations and permission level information associated with each registration of the plurality of setting registrations, in response to an output instruction for outputting the plurality of setting registrations to an outside, the plurality of setting registrations being registrations in which process settings for functions of a device are registered in advance, and
generate a list including at least one setting registration associated with permission level information indicating use permission for a user who transmits the output instruction, the at least one setting registration being among the plurality of setting registrations.

2. The control device according to claim 1,
wherein, in addition to the plurality of setting registrations and the permission level information associated with each registration of the plurality of setting registrations, the processor obtains user information associated with each registration of the plurality of setting registrations, and
wherein the processor generates the list including at least one setting registration associated with user information indicating the user who transmits the output instruction, the at least one setting registration being among the plurality of setting registrations.

3. The control device according to claim 1,
wherein the processor receives selection of a setting registration from the at least one setting registration in the list, the selected setting registration being to be output actually.

4. The control device according to claim 2,
wherein the processor receives selection of a setting registration from the at least one setting registration in the list, the selected setting registration being to be output actually.

5. A control device comprising:
a processor configured to
obtain a plurality of setting registrations and permission level information associated with each registration of the plurality of setting registrations, in response to an input instruction for inputting the plurality of setting registration to a second device, the plurality of setting registrations being registrations in which process settings for functions of a first device are registered in advance, and
generate a list including at least one setting registration associated with permission level information matching permission level information associated with a setting registration registered already for a corresponding function of the second device, the at least one setting registration being among the plurality of setting registrations.

6. The control device according to claim 5,
wherein, in addition to the plurality of setting registrations and the permission level information associated with each registration of the plurality of setting registrations, the processer obtains user information associated with each registration of the plurality of setting registrations, and
wherein the processer generates the list including at least one setting registration associated with user information indicating a user who transmits the input instruction, the at least one setting registration being among the plurality of setting registrations.

7. The control device according to claim 5,
wherein the processer receives selection of a setting registration from the at least one setting registration in the list, the selected setting registration being to be input actually.

8. The control device according to claim 6,
wherein the processer receives selection of a setting registration from the at least one setting registration in the list, the selected setting registration being to be input actually.

9. A control device comprising:
a processer configured to
obtain a plurality of setting registrations and permission level information associated with each registration of the plurality of setting registrations, in response to a copy instruction for copying the plurality of setting registrations to a second device, the plurality of setting registrations being registrations in which process settings for functions of a first device are registered in advance,
generate a first list including at least one setting registration associated with permission level information indicating use permission for a user who transmits the copy instruction, the at least one setting registration being among the plurality of setting registrations, and
generate a second list including at least one setting registration associated with permission level information matching permission level information associated with a setting registration registered already for a corresponding function of the second device, the at least one setting registration included in the second list being among the at least one setting registration included in the first list.

10. A non-transitory computer readable medium storing a program causing a computer to execute a process for control, the process comprising:
obtaining a plurality of setting registrations and permission level information associated with each registration of the plurality of setting registrations, in response to an output instruction for outputting the plurality of setting registrations to an outside, the plurality of setting registrations being registrations in which process settings for functions of a device are registered in advance, and
generating a list including at least one setting registration associated with permission level information indicating use permission for a user who transmits the output instruction, the at least one setting registration being among the plurality of setting registrations.
